(19) United States
(12) Patent Application Publication
(10) Pub. No.: US 2026/0314616 A1
(43) Pub. Date: Oct. 15, 2026

(54) COMPLEX COMPOSITIONS AND METHODS FOR PRESERVING PERISHABLE GOODS

(71) Applicant: Ryp Labs, Inc., Bothell, WA (US)

(72) Inventors: Antonio Francesko, Braga (PT); Benjamin Grady Jones, Seattle, WA (US); Rachida Bouchikh Zakour, Figueres (ES); Ahmed Mohamed Diaa Eldin Soliman, Kirkland, WA (US)

(73) Assignee: Ryp Labs, Inc., Bothell, WA (US)

(21) Appl. No.: 19/648,162

(22) Filed: Apr. 15, 2026

Related U.S. Application Data
(60) Provisional application No. 63/789,256, filed on Apr. 15, 2025.

(51) Int. Cl. A23B 7/154; A23B 2/75; A23B 2/762

(52) U.S. Cl. CPC A23B 7/154; A23B 2/75; A23B 2/762

(57) ABSTRACT

An antifungal composition including a first essential oil, a second essential oil, a third essential oil, a fourth essential oil, and an optional fifth essential oil where the composition is configured to reduce disease onset, pathogen spread, or a combination thereof. Further, a method of preventing spoilage comprising applying the composition to a perishable good. Further, a method of preventing spoilage comprising disposing the composition in proximity with a perishable good, in contact with a perishable good, or in a packaging of a perishable good.

### CROSS REFERENCE TO RELATED APPLICATION

This application claims the benefit of U.S. Application No. 63/789,256, filed on Apr. 15, 2025, the disclosure of which is hereby incorporated by reference in its entirety.

### BACKGROUND

The spoilage of fruits, vegetables, and plants is a cause of significant economic loss. Certain agents found in nature have an antimicrobial or anti-fungal effect of extending the post-harvest life of produce items. Shelf-life extending agents need to have certain features, such as being edible and having a pleasant smell. Further, the shelf-life extending agents that change the flavor, texture, or smell of the perishable goods may be disfavored by consumers.

Accordingly, shelf-life extending agents that have antimicrobial and anti-fungal effects, and which do not alter the texture, flavor, or smell of perishable goods are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Disclosed herein are compositions for reducing disease onset, pathogen spread, or a combination thereof.

### BRIEF DESCRIPTION OF DRAWINGS

The foregoing aspects and many of the attendant advantages of this invention will become more readily appreciated as the same become better understood by reference to the following detailed description, when taken in conjunction with the accompanying drawings, wherein:

FIG. 1 is a graph showing an example of the inhibition of Botrytis cinerea spores with various concentrations of composition 45% p-thymol, 10% geraniol, 20% citral, and 25% trans-cinnamaldehyde; and

FIGS. 2A-2B show an example experiment to determine the minimum inhibitory concentrations (MIC) of a composition including 30% p-thymol, 5% geraniol, 20% trans-2-decenal, 30% beta-thujaplicin, and 15% methyl anthranilate.

### DETAILED DESCRIPTION

Disclosed herein are compositions and methods for preventing the spoilage and/or pathogen spread of perishable goods. Essential oils may have antifungal properties, antibacterial properties, and/or properties that reduce pathogen spread on perishable goods. As used herein, the term essential oil refers to essential oils, components found in essential oils, naturally derived compounds, and compounds generally. Disclosed herein are combinations of essential oils that produce additive effects, that is, combining the properties of two or more individual essential oils. In some embodiments, the compositions are blends of any number of essential oils. Also disclosed herein are combinations of essential oils that produce combinatory and/or complementary effects, that is, have better properties or complementary properties than the two or more essential oils individually, resulting in overall improved performance. In some embodiments, the essential oils are selected from are selected from p-thymol, geraniol, citral, trans-cinnamaldehyde, eugenol, citronellol, methyl anthranilate, beta-thujaplicin, trans-2-decenal, 2-pine-4-ol, trans-2,cis-6-nonadienal, or a combination thereof.

In one aspect, disclosed herein is an antifungal composition including a first essential oil, a second essential oil, a third essential oil, and a fourth essential oil, wherein the composition is configured to reduce disease onset, pathogen spread, or a combination thereof.

In some embodiments, the first essential oil ranges from about 25% to about 75% of the antifungal composition. In some embodiments, the second essential oil ranges from about 2.5% to about 15% of the antifungal composition. In some embodiments, the third essential oil ranges from about 1% to about 35% of the antifungal composition. In some embodiments, the fourth essential oil ranges from about 10% to about 35% of the antifungal composition. In some embodiments, the first essential oil, the second essential oil, the third essential oil, the fourth essential oil, or combination thereof are selected from p-thymol, geraniol, citral, trans-cinnamaldehyde, eugenol, citronellol, methyl anthranilate, beta-thujaplicin, trans-2-decenal, 2-pine-4-ol, trans-2,cis-6-nonadienal, or a combination thereof.

In some embodiments, the first essential oil is p-thymol. In some embodiments, the second essential oil is geraniol. In some embodiments, the third essential oil is citral. In some embodiments, the fourth essential oil is trans-cinnamaldehyde. In some embodiments, the first essential oil is 45% of the antifungal composition, the second essential oil is 10% of the antifungal composition, the third essential oil is 20% of the antifungal composition, and the fourth essential oil is 25% of the antifungal composition.

In some embodiments, the antifungal composition further comprises a fifth essential oil. In some embodiments, the first essential oil, the second essential oil, the third essential oil, the fourth essential oil, the fifth essential oil, or combination thereof are selected from p-thymol, geraniol, citral, trans-cinnamaldehyde, eugenol, citronellol, methyl anthranilate, beta-thujaplicin, trans-2-decenal, 2-pine-4-ol, trans-2,cis-6-nonadienal, or a combination thereof. In some embodiments, the fifth essential oil ranges from 10% to 35% of the antifungal composition.

In another aspect, disclosed herein is an antifungal composition, including 45% p-thymol, 10% geraniol, 20% citral, and 25% trans-cinnamaldehyde, where the composition is configured to reduce disease onset, pathogen spread, or a combination thereof.

In yet another aspect, disclosed herein is an antifungal composition, including 70% p-thymol, 7.5% geraniol, 5% eugenol, 2.5% citronellol, and 15% methyl anthranilate, where the composition is configured to reduce disease onset, pathogen spread, or a combination thereof.

In another aspect, disclosed herein is an antifungal composition, including 30% p-thymol, 5% geraniol, 20% trans-2-decenal, 30% beta-thujaplicin, and 15% methyl anthranilate, where the composition is configured to reduce disease onset, pathogen spread, or a combination thereof.

In yet another aspect, disclosed herein is an antifungal composition, including 30% p-thymol, 8% methyl anthranilate, 25% trans-2-decenal, 7% trans-cinnamaldehyde, and 30% beta-thujaplicin, where the composition is configured to reduce disease onset, pathogen spread, or a combination thereof.

In another aspect is a method of preventing spoilage including applying the compositions disclosed herein to a perishable good.

In yet another aspect, disclosed herein is a method of preventing spoilage including disposing the compositions disclosed herein in proximity with a perishable good.

In some embodiments, the one or more essential oils includes volatile methane-based alcoholic terpenes, such as o-thymol, p-thymol, cuminol, perillol, carveol, piperitol, pulegol, terpiniol, and menthol. In some embodiments, the one or more essential oils includes volatile alcoholic terpenes, such as eugenol, isoeugenol, guaiacol, vanillin, chavicol, anol, cinnamyl alcohol, and b-thujaplicin. In some embodiments, the one or more essential oils includes volatile alcoholic terpenes, such as geraniol, and citronellol. In some embodiments, the one or more essential oils include volatile aromatic aldehyde or ketonic terpenes, such as menthone, carvone, pulegone, piperitone, p-anisal, o-anisal, phellandral, cuminal, perillal, and terpinene-7-al. In some embodiments, the one or more essential oils includes volatile linear aldehydes (monounsaturated), such as trans-2-hexenal, cis-2-hexenal. trans-2-heptenal, cis-2-heptenal, trans-2-octenal, cis-2-octenal, trans-2-nonenal, cis-2-nonenal, trans-2-decenal, cis-2-decenal, trans-2-dodecenal, and cis-2-dodecenal. In some embodiments, the one or more essential oils include volatile linear aldehydes (diunsaturated or polyunsaturated), such as trans, cis-2,4-octadienal, trans,trans-2,4-octandienal, trans,cis-2,4-nonadienal, trans, trans-2,4-nonadienal, trans, cis-2,4-decadienal, and trans, cis-2,4-dodecadienal. In some embodiments, the one or more essential oils include other volatile linear aldehydes, such as hexanal, heptanal, octanol, nonanal, decenal, dodecanal, trans-4-nonenal, and trans-2,cis-6-nonadienal. In some embodiments, the one or more essential oils include volatile lactones and pyrones, such as gamma-octalactone, gamma-nonalactone, gamma-decalactone, gamma-dodecalactone, delta-decalactone, and benzo dihydropyrone. In some embodiments, the one or more essential oils includes 4-(4-hydroxyphenyl)-2-butanone, ethyl methylphenylglycidate, and/or furaneol.

In a further aspect, disclosed herein is a method of preventing spoilage. In some embodiments, the method includes placing any of the compositions disclosed herein in contact with or in proximity to a perishable good. In some embodiments, the compositions disclosed herein are incorporated into packaging for a perishable good, such as boxes, bags, clamshells, stickers, and the like.

### EXAMPLES

Essential oils were tested to determine their microbial and antifungal properties.

Essential oils were tested for their ability to suppress the germination of fungal spores. The potency to suppress spores' germination indicates which essential oils might be more potent in delaying the disease onset in fresh produce. The spores from Botrytis cinerea (a major cause of grey rot in strawberries and grapes), and Colletotrichum gloeosporioides (causative of anthracnose in mangoes and papayas) were used in the assay. Solutions of potato dextrose broth (PDB) as growing media, tawed spores and essential oils diluted in ethanol were mixed into cleared mixtures and added into the wells of 96-well plates. The plates were film-sealed and incubated at 20° C. for up to 4 days. During that period the spores develop and render the solutions turbid, with degree of turbidity proportional to the growth of the spores. The degree of turbidity was expressed as optical density (OD), measuring absorbance using spectrophotometer at 600 nm. The obtained absorbances were compared with their respective controls (fungal spores in PDB and ethanol, without the essential oils). The concentration ranges are reported starting with the lowest concentration with statistically significant difference compared to the controls and ending with the concentrations that did not allow any growth of the spores during the 4 days.

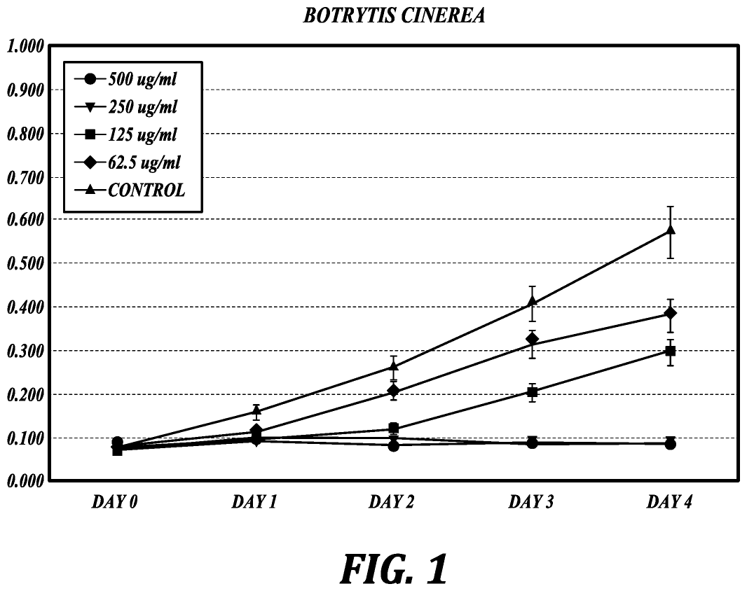

FIG. 1 is an example of the inhibition of Botrytis cinerea spores with various concentrations of composition 45% p-thymol, 10% geraniol, 20% citral, and 25% trans-cinnamaldehyde, from which the effective range of inhibition from 62.5 μg/mL (starting inhibition) to 250 μg/mL (complete inhibition).

The standard method for determination of minimum inhibitory concentrations (MIC) of antifungal agents (ref: Method for Determination of Broth Dilution Minimum Inhibitory Concentrations of Antifungal Agents for Conidia Forming Moulds. EUCAST E.DEF 9.3.2 Apr. 2020) was adapted to objectively evaluate susceptibility of the filamentous fungi due to inherent features of essential oils, i.e. high volatility, and low aqueous solubility. The selection of essential oils according to their MIC values renders outputs translated into how potent they are in slowing down the fungal disease spread, once there is an onset. The adaptation to standard method involved change in procedure to mixing the essential oils to aqueous solutions of warm potato dextrose agar (PDA). We used ethanol as a common solvent with good miscibility with water, set the temperature for the mixing to 50° C. and 5 minutes time for solidification of the essential oil-amended agar in Petri dishes. Different concentrations of essential oils were used to amend PDA, ranging between 50 μg/mL up to a maximum of 4000 μg/mL. To such amended agar plates, plugs from fresh cultures of Botrytis cinerea and Colletotrichum gloeosporioides were placed in the middle of the plate and the cultures were incubated at 20° C. during at least 9 days.

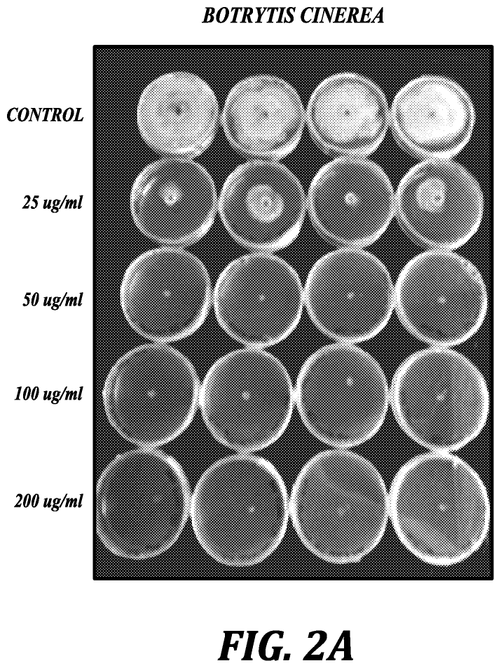

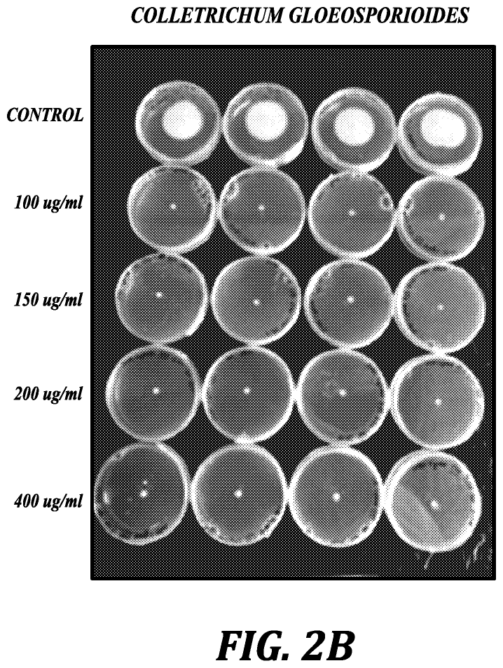

FIGS. 2A-2B show an example of an experiment to determine the MIC of composition 30% p-thymol, 5% geraniol, 20% trans-2-decenal, 30% beta-thujaplicin, and 15% methyl anthranilate for the two fungi using the Amended agar in Petri method. Here the MIC was found to be 50 μg/mL for Botrytis cinerea and 100 μg/mL for Colletotrichum gloeosporioides. The MIC concentration was the one where no growth of the culture was observed during at least 9 days of incubation.

Table 1 shows example outcomes obtained for Botrytis cinerea and Colletotrichum gloeosporioides summarizing the data needed for objectively selecting the best performing candidates, described in this application. The key attributes of performance of different mixtures in varying ratios are outlined allowing the selection based on the following criteria: i) complementarity in inhibiting the disease onset and pathogen spread, ii) synergy to allow use of lesser amounts of essential oils achieving the same or better effect, and iii) release estimate and a consequent range of duration of the effect, based on the vapor pressure values of individual essential oils.

| | COMPOSITION | | | | | |
|---|---|---|---|---|---|---|
| | | INHIBIT PATHOGEN | | INHIBIT PATHOGEN | | VAPOR PRESSURE / |
| COMPOUND | FUNGUS | ONSET (96-well plates) | | SPREAD (MIC) | | ESTIMATE RELEASE |
| Geraniol 100% | Botrytis cinerea | 62-500 | μg/mL | 400 | μg/mL | 36 ppm |
| | Colletotrichum gloeosporioides | NA (no spores acquired) | | 400 | μg/mL | Medium |
| Citronellol 100% | Botrytis cinerea | 125-500 | μg/mL | 200 | μg/mL | 329 ppm |
| | Colletotrichum gloeosporioides | NA | | 400 | μg/mL | Fast |
| Citral 100% | Botrytis cinerea | 62-250 | μg/mL | 400 | μg/mL | 263 ppm |
| | Colletotrichum gloeosporioides | NA | | 400 | μg/mL | Fast |
| p-Thymol 100% | Botrytis cinerea | 62-125 | μg/mL | 200 | μg/mL | 40 ppm |
| | Colletotrichum gloeosporioides | NA | | 100 | μg/mL | Medium |
| trans-Cinnamaldehyde 100% | Botrytis cinerea | 62-125 | μg/mL | 400 | μg/mL | 36 ppm |
| | Colletotrichum gloeosporioides | NA | | 400 | μg/mL | Medium |
| trans-2-decenal 100% | Botrytis cinerea | 31-62 | μg/mL | 400 | μg/mL | 103 ppm |
| | Colletotrichum gloeosporioides | NA | | 400 | μg/mL | Fast |
| beta-thujaplicin 100% | Botrytis cinerea | 31-62 | μg/mL | 50 | μg/mL | 0.12 ppm |
| | Colletotrichum gloeosporioides | NA | | 50 | μg/mL | Slow |
| Methyl anthranilate 100% | Botrytis cinerea | 62-125 | μg/mL | 150 | μg/mL | 21 ppm |
| | Colletotrichum gloeosporioides | NA | | 200 | μg/mL | Medium |
| Eugenol 100% | Botrytis cinerea | 62-500 | μg/mL | 800 | μg/mL | 13 ppm |
| | Colletotrichum gloeosporioides | NA | | 800 | μg/mL | Medium |
| Methyl anthranilate 15% | Botrytis cinerea | 62-250 | μg/mL | 150 | μg/mL | Medium |
| Eugenol 5% | | | | | | |
| p-Thymol 70% | | | | | | |
| Geraniol 7.5% | | | | | | |
| Citronellol 2.5% | Colletotrichum gloeosporioides | NA | | 100 | μg/mL | |
| Citral 20% | Botrytis cinerea | 31-250 | μg/mL | 150 | μg/mL | Medium |
| trans-Cinnamaldehyde 25% | | | | | | |
| Geraniol 10% | | | | | | |
| p-Thymol 45% | Colletotrichum gloeosporioides | NA | | 150 | μg/mL | |
| trans-2-decenal 25% | Botrytis cinerea | 15-31 | μg/mL | 50 | μg/mL | Wide range |
| p-Thymol 30% | | | | | | (Slow-Medium-Fast) |
| Methyl anthranilate 8% | | | | | | |
| beta-thujaplicin 30% | | | | | | |
| trans-Cinnamaldehyde 7% | Colletotrichum gloeosporioides | NA | | 50 | μg/mL | |
| Methyl anthranilate 15% | Botrytis cinerea | 31-62 | μg/mL | 100 | μg/mL | Wide range |

| beta-thujaplicin 30% | | | | | (Slow-Medium-Fast) |
|---|---|---|---|---|---|
| trans-2-decenal 20% | | | | | |
| Geraniol 5% | | | | | |
| p-Thymol 30% | Colletotrichum gloeosporioides | NA | 100 | μg/mL | |

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

We claim:

1. An antifungal composition comprising:
a first essential oil;
a second essential oil;
a third essential oil; and
a fourth essential oil, wherein the composition is configured to reduce disease onset, pathogen spread, or a combination thereof.

2. The antifungal composition of claim 1, wherein the first essential oil is present in a range from about 25% to about 75% of the antifungal composition.

3. The antifungal composition of claim 1, wherein the second essential oil is present in a range from about 2.5% to about 15% of the antifungal composition.

4. The antifungal composition of claim 1, wherein the third essential oil is present in a range from about 1% to about 35% of the antifungal composition.

5. The antifungal composition of claim 1, wherein the fourth essential oil is present in a range from about 10% to about 35% of the antifungal composition.

6. The antifungal composition of claim 1, wherein the first essential oil, the second essential oil, the third essential oil, the fourth essential oil, or combination thereof are selected from p-thymol, geraniol, citral, trans-cinnamaldehyde, eugenol, citronellol, methyl anthranilate, beta-thujaplicin, trans-2-decenal, 2-pine-4-ol, trans-2,cis-6-nonadienal, or a combination thereof.

7. The antifungal composition of claim 1, wherein the antifungal composition further comprises a fifth essential oil.

8. The antifungal composition of claim 7, wherein the first essential oil, the second essential oil, the third essential oil, the fourth essential oil, the fifth essential oil, or combination thereof are selected from p-thymol, geraniol, citral, trans-cinnamaldehyde, eugenol, citronellol, methyl anthranilate, beta-thujaplicin, trans-2-decenal, 2-pine-4-ol, trans-2,cis-6-nonadienal, or a combination thereof.

9. The antifungal composition of claim 7, wherein the fifth essential oil is present in a range from 10% to 35% of the antifungal composition.

10. A method of preventing spoilage comprising applying the composition of claim 1 to a perishable good.

11. A method of preventing spoilage comprising disposing the composition of claim 1 in proximity with a perishable good.

12. A method of preventing spoilage comprising disposing the composition of claim 1 in contact with a perishable good.

13. A method of preventing spoilage comprising incorporating the composition of claim 1 into a packaging of a perishable good.

14. An antifungal composition, comprising:
45% p-thymol;
10% geraniol;
20% citral; and
25% trans-cinnamaldehyde, wherein the composition is configured to reduce disease onset, pathogen spread, or a combination thereof.

15. An antifungal composition, comprising:
70% p-thymol;
7.5% geraniol;
5% eugenol;
2.5% citronellol; and
15% methyl anthranilate, wherein the composition is configured to reduce disease onset, pathogen spread, or a combination thereof.

16. An antifungal composition, comprising:
30% p-thymol;
5% geraniol;
20% trans-2-decenal;
30% beta-thujaplicin; and
15% methyl anthranilate, wherein the composition is configured to reduce disease onset, pathogen spread, or a combination thereof.

17. An antifungal composition, comprising:
30% p-thymol;
8% methyl anthranilate;
25% trans-2-decenal;
7% trans-cinnamaldehyde; and
30% beta-thujaplicin, wherein the composition is configured to reduce disease onset, pathogen spread, or a combination thereof.
